(19) United States
(12) Patent Application Publication
(10) Pub. No.: US 2026/0030859 A1
(43) Pub. Date: Jan. 29, 2026

(54) METHOD FOR OPTIMAL REGION OF INTEREST FRAME ACQUISITION FROM IMAGE SENSOR

(71) Applicant: Zebra Technologies Corporation, Lincolnshire, IL (US)

(72) Inventor: Sajan Wilfred, Kollam (IN)

(21) Appl. No.: 18/785,737

(22) Filed: Jul. 26, 2024

(51) Int. Cl. G06V 10/25; G06T 7/70; G06V 10/44

(52) U.S. Cl. CPC G06V 10/25; G06T 7/70; G06V 10/44; G06T 2207/20132; G06V 2201/07

(57) ABSTRACT

Methods for optimal region of interest frame acquisition are disclosed herein. An example computing system includes: one or more memories including computer-executable instructions stored thereon that, when executed by one or more processors cause the computing system to: capture, by an image acquisition assembly, a first low resolution image dataset; determine a first region of interest from the first low resolution image dataset; capture, by the image acquisition assembly, a first high resolution image dataset based on the first region of interest; capture, by the image acquisition assembly, a second low resolution image dataset; determine a second region of interest from the second low resolution image dataset; capture, by the image acquisition assembly, a second high resolution image dataset based on the second region of interest; and identify, based on one or more of: the first high resolution image dataset or the second high resolution image dataset, an image feature.

### BACKGROUND

Conventional techniques for machine vision, barcode scanning, and object recognition applications generally employ scanners with a high resolution image sensor capable of operating at a high frame rate to analyze objects that typically move at high speed across the scanners' fields of view.

High intensity illumination and optimal pixel integration (exposure) is typically necessary for continuously acquiring each high resolution frame, and decoding these high resolution image frames is computationally intensive. In particular, barcode localization and execution of symbology specific decode algorithms at candidate locations for these high resolution frames requires significant computational resources. The conventional techniques additionally require streaming larger amounts of data at high speed, higher cost sensors, and higher cost image processors. Further, such techniques generally result in higher power consumption, and despite such frames being high resolution, non-decodable static artifacts and areas of non-interest are included in many frames.

### SUMMARY

In an embodiment, the present invention is a computing system comprising: one or more processors; an image acquisition assembly; and one or more memories including computer-executable instructions stored thereon that, when executed by the one or more processors cause the computing system to: (i) capture, by the image acquisition assembly, a first low resolution image dataset; (ii) determine a first region of interest from the first low resolution image dataset; (iii) capture, by the image acquisition assembly, a first high resolution image dataset based on the first region of interest; (iv) obtain, by the image acquisition assembly, a second low resolution image dataset; (v) determine a second region of interest from the second low resolution image dataset; (vi) obtain, by the image acquisition assembly, a second high resolution image dataset based on the second region of interest; and (vii) identify, based on one or more of: (a) the first high resolution image dataset or (b) the second high resolution image dataset, an image feature.

In a variation of this embodiment, the image acquisition assembly is further configured to consecutively capture the first low resolution image dataset, the first high resolution image dataset, the second low resolution image dataset, and the second high resolution image dataset.

In another variation of this embodiment, (i) the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset, and (ii) the second set of image acquisition parameters are determined based on the first low resolution image dataset, and the fourth set of image acquisition parameters are determined based on the second low resolution image dataset.

In another variation of this embodiment, the first low resolution image dataset and the second low resolution image dataset correspond to a field of view of the image acquisition assembly and the first high resolution image dataset and the second high resolution image dataset correspond to respective first and second portions of the field of view of the image acquisition assembly.

In another variation of this embodiment, the computer-executable instructions, when executed by the one or more processors, further cause the computing system to: (i) determine the first region of interest based on one or more of: (i) rows of pixels of interest identified in the first low resolution image dataset, or (ii) columns of pixels of interest identified in the first low resolution image dataset; and (ii) determine the second region of interest based on one or more of: (a) rows of pixels of interest identified in the second low resolution image dataset, or (b) columns of pixels of interest identified in the second low resolution image dataset.

In another variation of this embodiment, the computer-executable instructions, when executed by the one or more processors, further cause the computing system to: (i) crop, based on the first region of interest associated with the first low resolution image dataset, an initial first high resolution image dataset corresponding to a field of view of the image acquisition assembly to generate the first high resolution image dataset corresponding to a first portion of the field of view of the image acquisition assembly; and (ii) crop, based on the second region of interest associated with the second low resolution image dataset corresponding to the field of view of the image acquisition assembly, an initial second high resolution image dataset to generate the second high resolution image dataset corresponding to a second portion of the field of view of the image acquisition assembly.

In another variation of this embodiment, the computer-executable instructions, when executed by the one or more processors, further cause the computing system to: (i) identify a symbology depicted within the identified image feature; and (ii) decode the symbology depicted within the identified image feature.

In another variation of this embodiment, identifying the image feature further includes: (i) identifying one or more objects included in the first region of interest and in the second region of interest; and (ii) determining one or more of: (i) a location of the one or more objects or (ii) a configuration of the one or more objects.

In another embodiment, the present invention is a computer-implemented method comprising: (i) capturing, by an image acquisition assembly, a first low resolution image dataset; (ii) determining a first region of interest from the first low resolution image dataset; (iii) capturing, by the image acquisition assembly, a first high resolution image dataset based on the first region of interest; (iv) obtaining, by the image acquisition assembly, a second low resolution image dataset; (v) determining a second region of interest from the second low resolution image dataset; (vi) obtaining, by the image acquisition assembly, a second high resolution image dataset based on the second region of interest; and (vii) identifying, based on one or more of: (a) the first high resolution image dataset or (b) the second high resolution image dataset, an image feature.

In another variation of this embodiment, the image acquisition assembly is further configured to consecutively capture the first low resolution image dataset, the first high resolution image dataset, the second low resolution image dataset, and the second high resolution image dataset.

In another variation of this embodiment, (i) the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset, and (ii) the second set of image acquisition parameters are determined based on the first low resolution image dataset, and the fourth set of image acquisition parameters are determined based on the second low resolution image dataset.

In another variation of this embodiment, the first low resolution image dataset and the second low resolution image dataset correspond to a field of view of the image acquisition assembly and the first high resolution image dataset and the second high resolution image dataset correspond to respective first and second portions of the field of view of the image acquisition assembly.

In another variation of this embodiment, the computer implemented method further comprises: (i) determining the first region of interest based on one or more of: (a) rows of pixels of interest identified in the first low resolution image dataset, or (b) columns of pixels of interest identified in the first low resolution image dataset; and (ii) determining the second region of interest based on one or more of: (a) rows of pixels of interest identified in the second low resolution image dataset, or (b) columns of pixels of interest identified in the second low resolution image dataset.

In another variation of this embodiment, the computer implemented method further comprises: (i) cropping, based on the first region of interest associated with the first low resolution image dataset, an initial first high resolution image dataset corresponding to a field of view of the image acquisition assembly to generate the first high resolution image dataset corresponding to a first portion of the field of view of the image acquisition assembly; and (ii) cropping, based on the second region of interest associated with the second low resolution image dataset corresponding to the field of view of the image acquisition assembly, an initial second high resolution image dataset to generate the second high resolution image dataset corresponding to a second portion of the field of view of the image acquisition assembly.

In another variation of this embodiment, the computer implemented method further comprises: (i) identifying a symbology depicted within the identified image feature; and (ii) decoding the symbology depicted within the identified image feature.

In another variation of this embodiment, identifying the image feature further includes: (i) identifying one or more objects included in the first region of interest and in the second region of interest; and (ii) determining one or more of: (a) a location of the one or more objects or (b) a configuration of the one or more objects.

In yet another embodiment, the present invention is a non-transitory computer readable medium containing program instructions that when executed, cause a computer to: (i) capture, by an image acquisition assembly, a first low resolution image dataset; (ii) determine a first region of interest from the first low resolution image dataset; (iii) capture, by the image acquisition assembly, a first high resolution image dataset based on the first region of interest; (iv) obtain, by the image acquisition assembly, a second low resolution image dataset; (v) determine a second region of interest from the second low resolution image dataset; (vi) obtain, by the image acquisition assembly, a second high resolution image dataset based on the second region of interest; and (vii) identify, based on one or more of: (a) the first high resolution image dataset or (b) the second high resolution image dataset, an image feature.

In another variation of this embodiment, the image acquisition assembly is further configured to consecutively capture the first low resolution image dataset, the first high resolution image dataset, the second low resolution image dataset, and the second high resolution image dataset.

In a variation of this embodiment, (i) the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset, and (ii) the second set of image acquisition parameters are determined based on the first low resolution image dataset, and the fourth set of image acquisition parameters are determined based on the second low resolution image dataset.

In another variation of this embodiment, the first low resolution image dataset and the second low resolution image dataset correspond to a field of view of the image acquisition assembly and wherein the first high resolution image dataset and the second high resolution image dataset correspond to respective first and second portions of the field of view of the image acquisition assembly.

In a variation of this embodiment, the program instructions, when executed by the one or more processors, further cause the computer to: (i) determine the first region of interest based on one or more of: (a) rows of pixels of interest identified in the first low resolution image dataset, or (b) columns of pixels of interest identified in the first low resolution image dataset; and (ii) determine the second region of interest based on one or more of: (a) rows of pixels of interest identified in the second low resolution image dataset, or (b) columns of pixels of interest identified in the second low resolution image dataset.

In another variation of this embodiment, the program instructions, when executed by the one or more processors, further cause the computer to: (i) crop, based on the first region of interest associated with the first low resolution image dataset, an initial first high resolution image dataset corresponding to a field of view of the image acquisition assembly to generate the first high resolution image dataset corresponding to a first portion of the field of view of the image acquisition assembly; and (ii) crop, based on the second region of interest associated with the second low resolution image dataset corresponding to the field of view of the image acquisition assembly, an initial second high resolution image dataset to generate the second high resolution image dataset corresponding to a second portion of the field of view of the image acquisition assembly.

In another variation of this embodiment, the program instructions, when executed by the one or more processors, further cause the computer to: (i) identify a symbology depicted within the identified image feature; and (ii) decode the symbology depicted within the identified image feature.

In another variation of this embodiment, identifying the image feature further includes: (i) identifying one or more objects included in the first region of interest and in the second region of interest; and (ii) determining one or more of: (a) a location of the one or more objects or (b) a configuration of the one or more objects.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates a perspective view of a checkout workstation, in accordance with some embodiments described herein.

FIG. 1B illustrates a perspective view of a handheld scanner, in accordance with some embodiments described herein.

FIG. 1C depicts an example operating environment for a machine vision imaging system, in accordance with some embodiments described herein.

FIG. 2 is a block diagram of an example logic circuit for implementing example methods and/or operations for optimal region of interest frame acquisition, in accordance with some embodiments described herein.

FIG. 3A illustrates a conventional technique for image frame acquisition.

FIG. 3B illustrates an exemplary interleaved technique for optimal region of interest frame acquisition, in accordance with some embodiments described herein.

FIG. 4 illustrates a signal diagram associated with an exemplary image acquisition process for optimal region of interest frame acquisition, in accordance with some embodiments described herein.

FIG. 5 depicts an exemplary computer-implemented method for optimal region of interest frame acquisition, in accordance with the techniques disclosed herein, in accordance with some embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present aspects may relate to, inter alia, a computing system for optimal region of interest frame acquisition. An example computing system may capture a low resolution image dataset by an image acquisition assembly, and determine a region of interest based on the low resolution image dataset. For instance, an item or object that is affixed with a symbology may be moving through the field of view of the image acquisition assembly and the computing system may identify a portion of the field of view including the item or object in the field of view (e.g., a portion of the FOV including the item or object that is smaller than the entire FOV) as a region of interest. The computing system may capture, by the image acquisition assembly, a high resolution image dataset based on the region of interest identified in the low resolution image dataset. The computing system may analyze the high resolution image dataset to identify an item or object that is moving through the field of view of the image acquisition assembly. More specifically, the low resolution image dataset maybe analyzed (e.g., by analyzing the high resolution image dataset) to identify the item or object moving through the field of view without analyzing areas of non-interest in the low resolution image dataset. The computing system may repeatedly capture low resolution image datasets and corresponding high resolution image datasets as the item or object moves through the field of view of the image acquisition assembly.

Advantageously, analyzing the high resolution image datasets in this manner reduces the computational load of the computing system by avoiding computationally intensive analysis of areas of non-interest in the image datasets. Moreover, in the disclosed invention, fewer high resolution image datasets are captured in the aggregate, and additionally, these high resolution image datasets are smaller. By analyzing such high resolution image datasets to identify the item or object moving through the field of view, an exemplary computing system can stream smaller amounts of data, reduce power consumption, and expend fewer computational resources, thereby requiring less processing time.

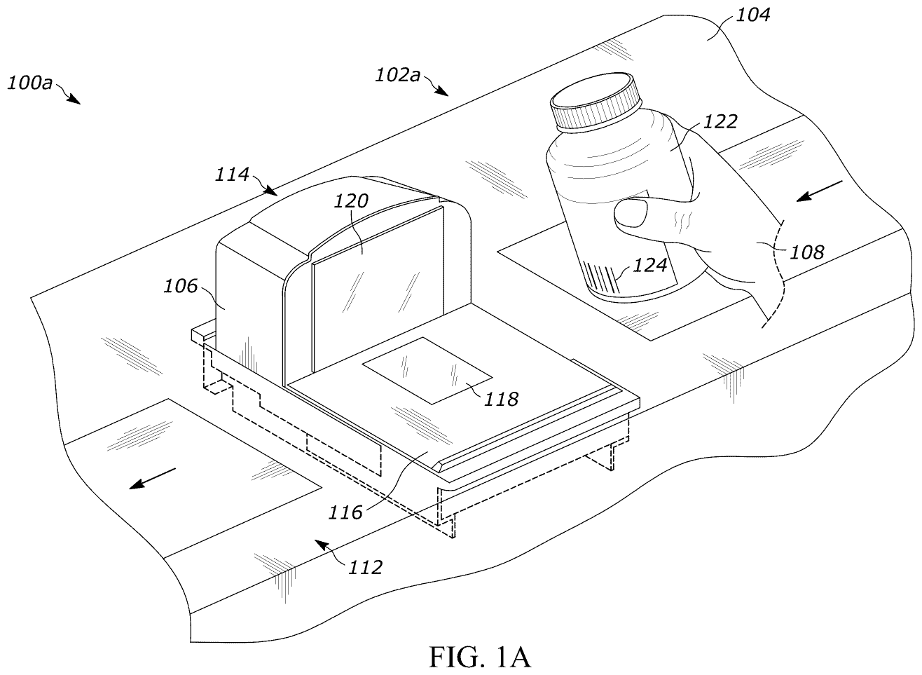

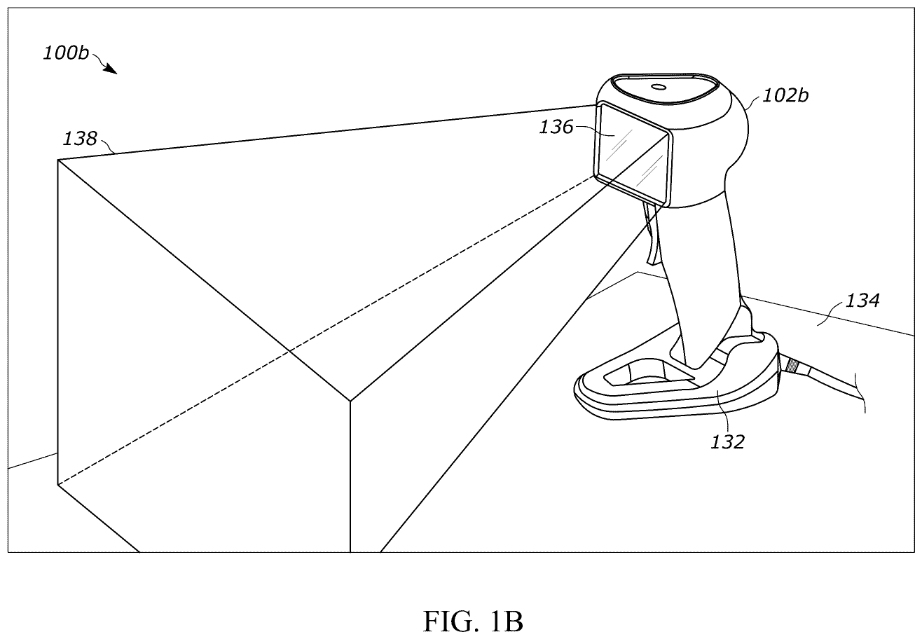

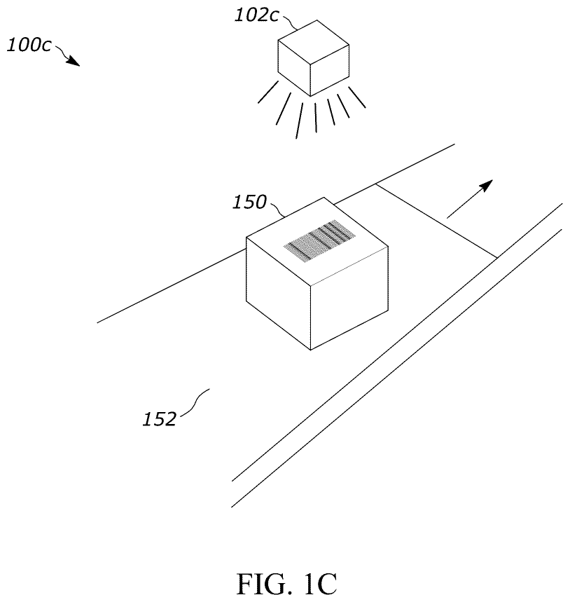

Referring now to the drawings, FIG. 1A illustrates a perspective view of a point-of-sale (POS) system 100a having a workstation 102a with a counter 104 and a bi-optical (also referred to as “bi-optic”) barcode reader 106 positioned partially within the workstation 102a. The POS system 100a is often managed by a store employee such as a clerk 108. However, in other cases the POS system 100a may be a part of a so-called self-checkout lane where instead of a clerk, a customer is responsible for checking out his or her own products.

The barcode reader 106 includes a lower housing 112 and a raised housing 114. The lower housing 112 includes a top portion 116 with a first optically transmissive window 118 positioned therein along a generally horizontal plane relative to the overall configuration and placement of the reader 106. The raised housing 114 is configured to be extend above the top portion 116 and includes a second optically transmissive window 120 positioned in a generally upright plane relative to the top portion 116 and/or the first optically transmissive window 118.

In practice, products, such as, for example, the bottle 122, are swiped past the reader 106 such that a barcode 124 associated where the product 122 is digitally read through at least one of the first and second optically transmissive windows 118, 120. This is particularly done by positioning the product 122 within the fields of view (FsOV) of the digital imaging sensor(s) housed inside the reader 106 to allow the sensor(s) to capture image data and transmit that data for further processing.

In another embodiment, as depicted in FIG. 1B, an exemplary scanning station 100b is formed from a handheld scanner 102b and a stationary cradle 132 mounted to a scanning surface 134. The handheld scanner 102b rests in the stationary cradle to establish a hands-free scanning mode, also termed a presentation mode, for scanning objects. The handheld scanner 102b therefor operates as an imaging reader, having a scanning window 136, behind which may be an illumination source (not shown) and an imaging stage (not shown). In the hands-free scanning mode, the handheld scanner 102b has a field of view (FOV) 138 illuminated by the imaging reader. In accordance with the techniques herein, the handheld scanner 102b captures images of an object for identification and imaging at the FOV 138. A trigger may be used to initiate a hands-free scanning mode, in some examples. In some examples, the hands-free scanning made is initiative by placement of the scanner 102b into the cradle 132.

In another embodiment, as depicted in FIG. 1C, an machine vision system 100c includes a machine vision device 102c (or imaging device 102c). As shown in FIG. 1C, a box 150 is moving on a conveyor belt 152 past a field of view of an imaging device 102c. The imaging device 102c can capture images of an object (e.g., the box 150), and/or the symbology (e.g., a barcode) thereon, moving through the associated FOV in order to identify the object.

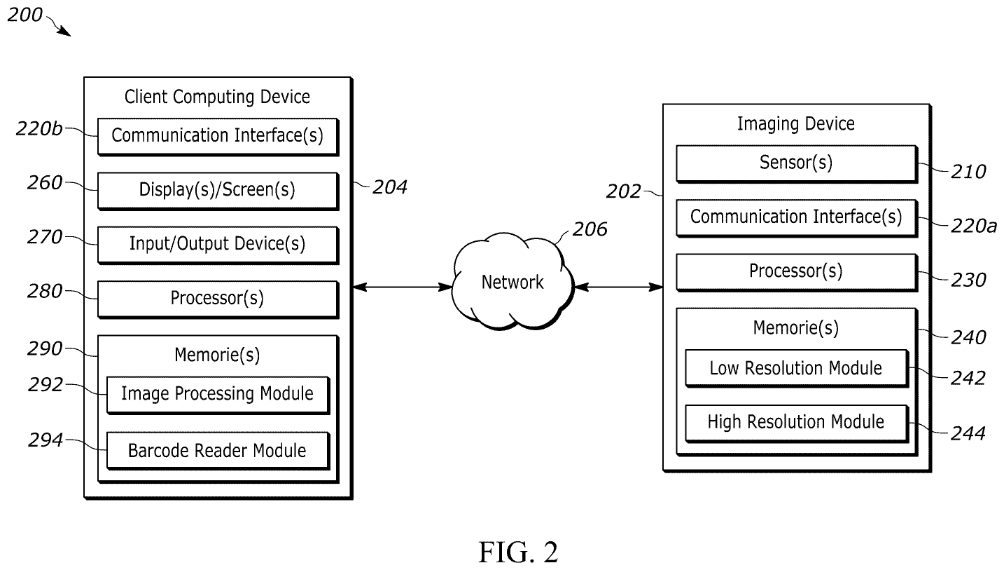

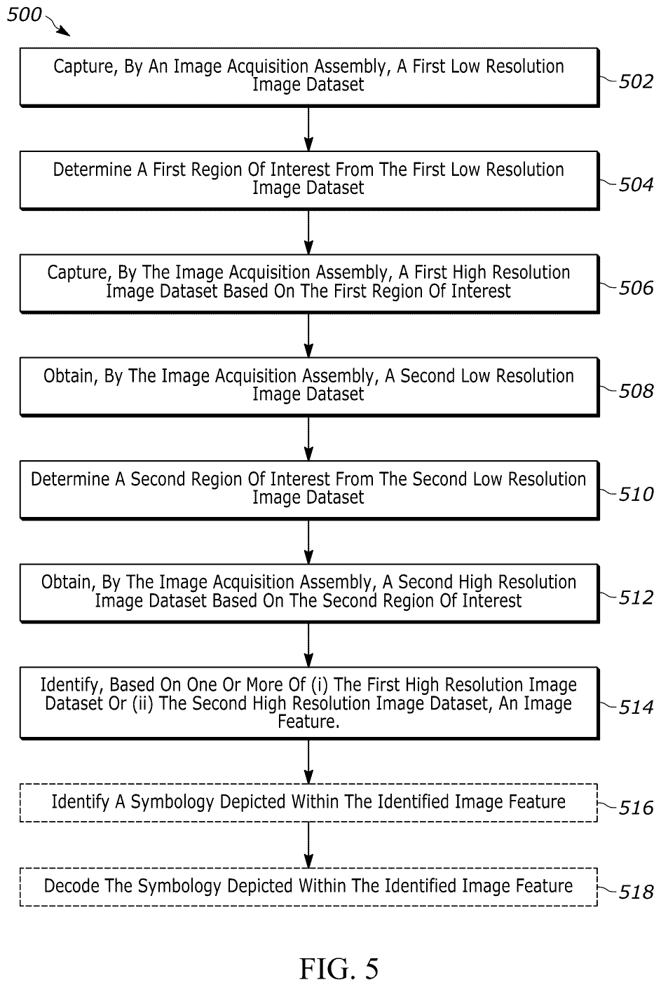

FIG. 2 is a block diagram representative of an example computing environment 200 capable of implementing the example methods and/or operations described herein, including, for example, one or more steps of the method 500 of FIG. 5. The computing environment 200 of FIG. 2 includes an imaging device 202, a client computing device 204, and a network 206. The exemplary network 206 of FIG. 2 may be a single communication link directly connecting the imaging device 202 and the client computing device 204 (e.g., a direct wireless link), or one or more networks 206 may include multiple links and/or communication networks of one or more types (e.g., one or more wired and/or wireless local area networks (LANs), and/or one or more wired and/or wireless wide area networks (WANs) such as the Internet, public networks, private networks, etc.). For ease of reading herein (and not for limitation purposes), the one or more networks 206 may be referred to using the singular tense.

The example imaging device 202 of FIG. 2 includes one or more sensors 210, one or more communication interfaces 220a, one or more processors 230, and one or more memories 240.

The example imaging device 202 (also referred to herein as an “image acquisition assembly”) of FIG. 2 includes one or more sensors 210 for detecting and/or capturing image data for optimal region of interest frame acquisition as described herein. In some examples, the imaging device 202 may be implemented in the systems 100a, 100b, and/or 100c discussed above with respect to FIGS. 1A, 1B, and 1C. For instance, the barcode reader 106 of FIG. 1A may include the imaging device 202, the imaging reader of the handheld scanner 102b of FIG. 1B may include the imaging device 202, and/or the machine vision device 102c may include the imaging device 202, in various embodiments.

The example sensors 210 of FIG. 2 may be (or include) hardware sensors (e.g., image sensors) configured to capture image data and/or image datasets. In some embodiments, the sensors 210 may be an external sensor 210 that is communicatively coupled to the imaging device 202 and/or the client computing device 204 via a network (e.g., the network 206), a direct communication link, or by another suitable communication means. In various embodiments, the sensors 210 may be configured to receive instructions from a device included in the example computing environment 200 (e.g., the imaging device 202, the client computing device 204, or another device not depicted in FIG. 2). The set of instructions sent to the sensors 210 may include a set of image acquisition parameters for capturing image data of a particular field of view (FOV). In some embodiments, the image acquisition parameters of the sensors 210 may be adjusted (e.g., in real-time, periodically, in response to an event, etc.) to alter the type, resolution, magnification, etc., of the image data captured by the sensors 210.

The one or more communication interface 220a may enable communication with other machines (e.g., the client computing device 204) via, for example, one or more networks 206. The example communication interface 220a includes any suitable type of communication interface(s) (e.g., wired and/or wireless interfaces) configured to operate in accordance with any suitable protocol(s). For example, the communication interfaces 220a may be configured to transmit and receive data using a suitable wired communication protocol such as an Ethernet protocol, a USB protocol, a UART protocol, an I2C protocol, a SPI protocol, or wireless communication protocols such as a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wired or wireless communication protocols. In some embodiments, for data throughput and efficiency reasons, a combination of such protocols may also be used as the communication interface 220a. In some embodiments, the communication interface 220a may be a network interface controller (NIC) and may include any suitable NICs, such as wired/wireless controllers (e.g., Ethernet controllers), and facilitate bidirectional/multiplexed networking over the network 206 between the imaging device 202 and the client computing device 204 and/or other components of the environment 200 (e.g., a remote computing device, another imaging device, etc.).

The processors 230 may include, for example, one or more microprocessors, controllers, and/or other suitable types of processors. The example imaging device 202 of FIG. 2 includes memories 240 (e.g., volatile memory, non-volatile memory) accessible by the processor 230 (e.g., via a memory controller). The example processor 230 interacts with the memory 240 to obtain, for example, machine-readable instructions stored in the memory 240 corresponding to, for example, the operations represented by the flowcharts of this disclosure (e.g., the flowchart 500 of FIG. 5). Additionally or alternatively, machine-readable instructions corresponding to the example operations described herein may be stored on one or more removable media (e.g., a compact disc, a digital versatile disc, removable flash memory, etc.) that may be coupled to the computing environment 200 to provide access to the machine-readable instructions stored thereon.

The example memories 240 included in the imaging device 202 of FIG. 2 may include a low resolution module 242 and a high resolution module 244. The low resolution module 242 may include computer-executable instructions for capturing low resolution image data, and or image datasets, by an image sensor (e.g., the one or more sensors 210 of the imaging device 202), and the high resolution module 244 may include computer-executable instructions for capturing high resolution image data, and/or image datasets, by an image sensor (e.g., the one or more sensors 210 of the imaging device 202). The low resolution image data may generally correspond to a field of view (FOV) of the imaging device 202 (or a portion of the FOV of the image device 202).

In various embodiments, the high resolution image data may correspond to a portion of the FOV included in the low resolution image data (e.g., or at least a smaller portion of the FOV as compared to the FOV of the low resolution image data). For example, the low resolution image data may be an image of an entire checkout area and the high resolution image data may be an image of a particular object within the checkout area. In some embodiments, the imaging device 202 (e.g., the low resolution module 242) may send low resolution image data to the client computing device 204 (e.g., to the image processing module 292) and the client computing device 204 may identify a region of interest in the low resolution image data. The region of interest identified may then be sent to the imaging device 202 (e.g., to the high resolution module 244) and the imaging device 202 may capture high resolution image data corresponding to the region of interest (e.g., encompassing the region of interest). In other embodiments, the high resolution image data may correspond to the FOV of the imaging device 102 (similar to the low resolution image data), and the high resolution module 244 may include instructions for cropping the high resolution image data based on a region of interest identified in the low resolution image data (e.g., identified by the image processing module 292). Moreover, the high resolution image data may be generated by cropping an initial high resolution image data based on a region of interest in corresponding low resolution image data. That is, after a region of interest is identified in a low resolution image, a subsequent high resolution image may be cropped to include only the region of interest.

In some embodiments, the high resolution module 244 may include instructions for capturing, and/or acquiring, the high resolution image data based on a region of interest identified in corresponding low resolution image data (e.g., low resolution image data captured immediately prior to capturing the high resolution image data). Moreover and in variations of these embodiments, the low resolution module 242 and the high resolution module 244 may work together to consecutively capture, and/or obtain, low resolution image data and high resolution image data at high speeds.

The low resolution module 242 may additionally include a set of computer-executable instructions that cause the sensors 210 to operate in accordance with a set of image acquisition parameters for capturing low resolution image data (e.g., image acquisition resolution, image acquisition exposure time, image acquisition field of view, etc.). Moreover, the initial, or first, set of image acquisition parameters may be for capturing first low resolution image data of an area of interest within the FOV of the imaging device 202 (e.g., an initial set of parameters for capturing the first image of an object moving through the area of interest). In some embodiments and as an example, as an object moves thorough an area of interest (e.g., within the FOV of the imaging device 202) the low resolution module 242 may adjust the initial set of image acquisition parameters accordingly to capture subsequent low resolution image data (e.g., adjust the focus of the low resolution image acquisition parameters as the object moves). In some embodiments, the low resolution module 242 may only include one set of image acquisition parameters for capturing low resolution image data.

For instance, in some examples, after the low resolution module 242 captures an image using the initial set of image acquisition parameters, the imaging device 202 may send the captured image to the client computing device 204, which may in turn analyze the captured image to identify a region of interest and send the imaging device 202 a second set of image acquisition parameters based on the identified region of interest (as discussed in greater detail below). Moreover, in other examples, the memorie(s) 240 of the imaging device 202 may be configured to locally analyze the captured image to identify a region of interest and determine the second set of image acquisition parameters based on the identified region of interest

In any case, the high resolution module 244 may include a set of computer-executable instructions that cause the sensors 210 to operate in accordance with the second set of image acquisition parameters for capturing high resolution image data.

For instance, in some examples, after the high resolution module 244 captures an image using the second set of image acquisition parameters, the imaging device 202 may send the captured image to the client computing device 204, which may in turn analyze the captured image to identify an object, symbology, indicia, etc., in the captured image. Moreover, in some examples, memorie(s) 240 of the imaging device 202 may be configured to locally analyze the captured image to identify an object, symbology, indicia, etc., in the captured image.

The example client computing device 204 of FIG. 2 may be an individual server, a group (e.g., cluster) of multiple servers, a mobile computing device (e.g., a smart phone, a tablet, a laptop, a wearable device, etc.), or another suitable type of computing device or system (e.g., a collection of computing resources). In some aspects the client computing device 204 may be a personal portable device of a user. For example, the client computing device 204 may be the property of a customer, a company, an organization, etc. The example client computing device 204 may include a communication interface 220b, one or more displays/screens 260, one or more input/output devices 270, one or more processors 280, and/or one or more memories 290.

The includes communication interfaces 220b may enable communication with other machines and/or devices via, for example, the one or more networks 206. Similar to the communication interface 220a, the communication interface 220b includes any suitable type of communication interface(s) (e.g., wired and/or wireless interfaces) configured to operate in accordance with any suitable protocol(s).

The displays/screens 260 may present or display information to a user. The displays/screens 260 may use any suitable display technology (e.g., LED, OLED, LCD, etc.), and in some embodiments may be integrated with I/O device 270 as a touchscreen display. Further, I/O device 270 and display 260 may combine to form an integral user interface to enable a user of the client computing device 204 to interact with graphical user interfaces (GUIs) provided by client computing device 204. For example, the displays/screens 260 may be configured to present low resolution image data and/or high resolution image data captured by the imaging device 202 for review by a user. In some embodiments, the display 260 may not be integral to the client computing device 204 and may receive instructions from the client computing device 204 via wired and/or wireless transmissions over communication interface 220b, for example.

The input/output (I/O) devices 270 may enable receipt of user input and communication of output data to the user. The input/output (I/O) devices 270 may include one or more suitable types of user input devices, such as keyboards, touch screen displays, microphones, mice, touchpads, and/or any suitable types of remote and/or local user input devices. Further, the I/O devices 270 may include one or suitable types of output devices, such as touch screen displays, speakers, and the like. For example, the I/O devices 270 may enable a user to manually adjust the image acquisition parameters from the low resolution module 242 and/or the high resolution module 244 of the imaging device 202 (e.g., via the communication interface 220b and over the network 206). In some embodiments, the I/O devices 270 may include one or more local interfaces, and/or may include one or more remote interfaces that are communicatively connected to the client computing device 204 and/or the imaging device 202 via the network 206 (e.g., that are provided by an application, web browser, or other software executing on a device of a user). For ease of reading (and not limitation) purposes, I/O device(s) 270 may be referred to herein using the singular tense.

The processors 280 may include one or more microprocessors, controllers, and/or any suitable type of processor, and the memories 290 (e.g., volatile memory, non-volatile memory) may be accessible by the processor 280 (e.g., via a memory controller). The processor 280 may interact with the memory 290 to obtain, for example, machine-readable instructions stored in the memory 290 corresponding to, for example, the operations represented by the flowcharts of this disclosure.

The memories 290 of the client computing device 204 of FIG. 2 may store instructions for executing an image processing module 292. In some embodiments, the client computing device 204 may receive image data (e.g., low resolution image data and/or high resolution image data) from the image device 202. The image processing module 292 may include instructions for determining a region of interest, or regions of interest, in image data acquired, and/or captured by the imaging device 202 (e.g., a region of interest in the low resolution image data obtained by the low resolution module 242). In some embodiments, the region(s) of interest may be determined based on rows and/or columns depicting an object or indicia of interest identified in the associated image data. For example, a region of interest may include an object/item affixed with a barcode, or another symbology/indicia, that can be decoded (e.g., by the barcode reader module 294). In some examples, the image processing module 292 may determine image acquisition parameters associated with capturing subsequent images including the region of interest. The client computing device 204 may send an indication of the determined region of interest, and/or the image acquisition parameters associated therewith, to the imaging device 202, which may in turn capture additional images (e.g., high resolution images) based on the determined region of interest and/or the image acquisition parameters associated therewith.

Additionally and in some embodiments, the image processing module 292 may include instructions for identifying image features within a region of interest based on image data from the imaging device 202 (e.g., based on high resolution image data from the imaging device 202). Moreover, the image features may be identified by identifying object(s)/item(s) included in the region of interest and determining a location and/or a configuration of the object(s). For instance, in a retail setting, a particular retail item, produce item, etc., may be identified in the region of interest. As another example, in a factory or assembly line setting, a configuration of items may be identified in a region of interest (e.g., to determine whether the correct items are present for a particular stage of assembly, whether a set of items are assembled correctly, etc.). Furthermore, the image processing module 292 may include instructions for identifying a symbology depicted within, or associated with, the identified image feature.

The example memories 290 included in the client computing device 204 of FIG. 2 may also store instructions for executing a barcode reader module 294. In some embodiments, objects included in the FOV of the imaging device may generally have a visible, or at least partially visible, symbology (e.g., a barcode) affixed/imprinted thereon. In various embodiments, the barcode reader module 294 may include instructions for decoding the symbology depicted within identified image features. The barcode reader module 294 may additionally include instructions for determining an identification of an object included, or depicted within, the image feature based on the decoded symbology, and may include instructions for communicating the identification of the object to other components of the example computing environment 200 (e.g., the image processing module 292).

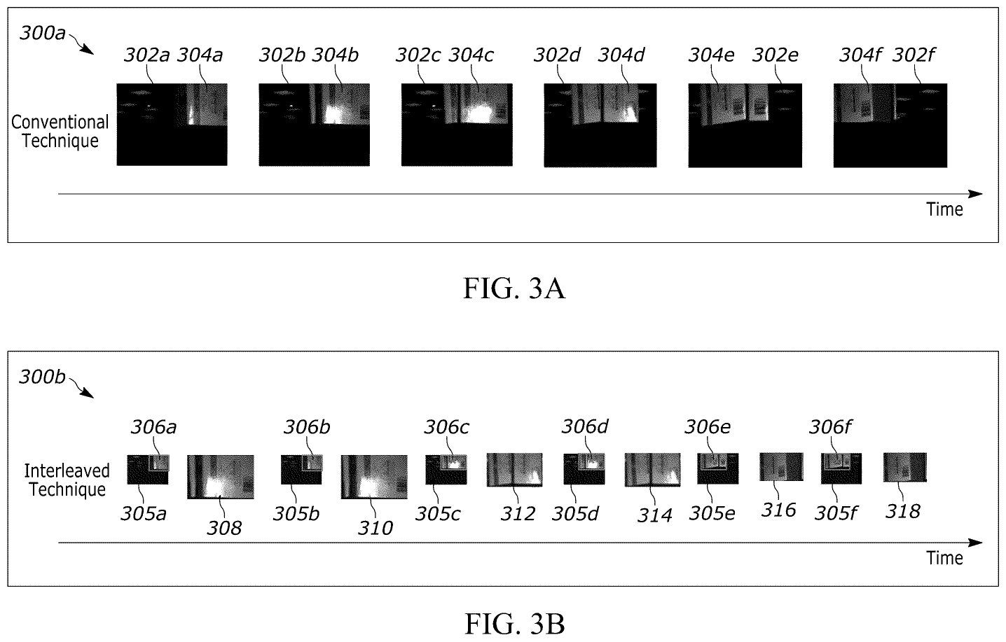

FIG. 3A depicts a conventional technique 300a for frame acquisition from image sensors. The conventional technique includes capturing and/or acquiring a sequence of images 302a-302f (e.g., 302a, 302b, 302c, 302d, 302e, 302f) at a particular resolution, and analyzing each image (e.g., 302a-302f) to identify indicia and/or symbology 304a-304f (e.g., 304a, 304b, 304c, 304d, 304e, 304f) associated with region of interest corresponding to a moving object. Typically, the conventional techniques include capturing a sequence of images at a high resolution, and consequently, evaluating and acquiring each of these high resolution images can be computationally expensive.

FIG. 3B depicts an exemplary interleaved technique 300b for optimal region of interest frame acquisition from image sensors as provided herein. The exemplary interleaved technique includes capturing and/or acquiring a sequence of low resolution images 305a-305f (e.g., 305a, 305b, 305c, 305d, 305e, 305f), and identifying respective regions of interest 306a-306f (e.g., 306a, 306b, 306c, 306d, 306e, 306f), or ROIs 306a-306f, (e.g., ROIs encompassing the indicia/symbology 304a-304f of FIG. 3A) in the low resolution images 305a-305f. The exemplary interleaved technique 300b includes capturing and/or acquiring high resolution images 308-318 (e.g., 308, 310, 312, 314, 316, and 318) corresponding to the identified regions of interest 306a-306f for each of the low resolution images 305a-305f. Accordingly, the exemplary interleaved method reduces the computation load of frame acquisition, as compared to the conventional techniques depicted in FIG. 3A. Moreover, analyzing the low resolution images 305a-305f to identify the regions of interest 306a-306f, as opposed to the conventional techniques that analyze high resolution images to identify regions of interest (e.g., as depicted in FIG. 3B), requires less processing time and fewer computational resources. Additionally, analyzing only the smaller size high-resolution images 308-318 corresponding to the regions of interest 306a-306f (as shown in FIG. 3B), and not the entirety of the high resolution images 302a-302f (as shown in FIG. 3A), further reduces the computational load as compared to the conventional techniques depicted in FIG. 3A.

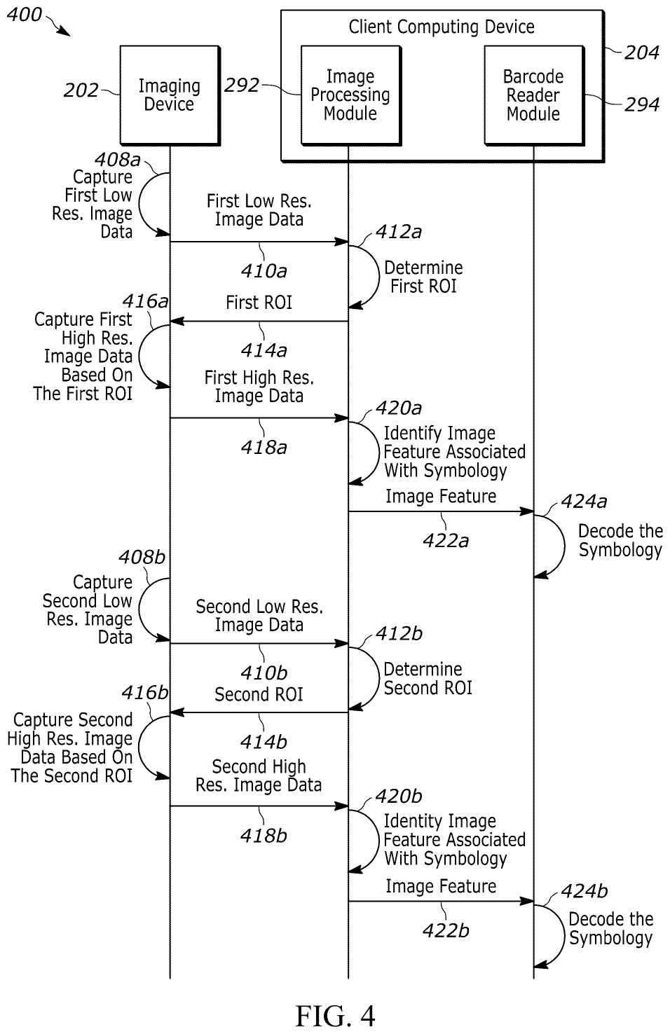

FIG. 4 depicts a signal diagram associated with an exemplary optimal region of interest frame acquisition process 400, in accordance with some embodiments. The acquisition process 400 includes communication between an imaging device 202 and a client computing device 204. The client computing device 204 may include an image processing module 292 and a barcode reader module 294, which may be communicatively connected via the communication interfaces 220a, 220b over the network 206, as described above with respect to FIG. 2. In some embodiments the image processing module 292 and the barcode reader module 294 may be included in the imaging device 202, as opposed to being included in the client computing device 204 as depicted in FIG. 4.

The process 400 may begin when the imaging device 202 captures first low resolution image data (line 408a) and sends the first low resolution image data to the image processing module 292 (line 410a). The image processing module 292 may then determine a first region of interest (ROI) in the first low resolution image data (line 412a), and the image processing module 292 may send the first region of interest to the imaging device 202 (line 414a). The imaging device 202 may then capture first high resolution image data based on the first region of interest (416a), and the imaging device 202 may send the first high resolution image data to the image processing module 292 (line 418a). The image processing module 292 may then identify an image feature, or features, associated with a symbology included in the first high resolution image data (line 420a). The image processing module 292 may then send the image feature (e.g., and/or the first high resolution image data) to the barcode reader module 294 (line 422a), and the barcode reader module 294 may decode the symbology depicted in the first high resolution image data (line 424a).

The imaging device 202 may then capture second low resolution image data (line 408b) and send the second low resolution image data to the image processing module 292 (line 410b). The image processing module 292 may then determine a second region of interest (ROI) in the second low resolution image data (line 412b), and the image processing module 292 may send the second region of interest to the imaging device 202 (line 414b). The imaging device 202 may then capture second high resolution image data based on the second region of interest (416b), and the imaging device 202 may send the second high resolution image data to the image processing module 292 (line 418b). The image processing module 292 may then identify an image feature, or features, (e.g., the same or different image feature of lines 420a and 422a) associated with a symbology included in the second high resolution image data (line 420b). The image processing module 292 may then send the image feature (e.g., and/or the second high resolution image data) to the barcode reader module 294 (line 422b), and the barcode reader module 294 may decode the symbology depicted in the second high resolution image data (line 424b).

The optimal region of interest frame acquisition process 400 described with respect to lines 408a-424a may be repeated any number of times.

FIG. 5 depicts an exemplary computer-implemented method 500 for implementing the techniques for optimal region of interest frame acquisition from image sensors disclosed herein, according to an aspect. The method 500 may be implemented by the processors 230, the processors 280, and/or other suitable processors, etc., executing instructions stored on the memories 240, the memories 290, and/or another suitable non-transitory computer readable medium, etc., described above with respect to FIG. 2-4.

The method 500 may begin at block 502 when a first low resolution image dataset is captured by an image acquisition assembly. At block 504, a first region of interest from the first low resolution image dataset is determined and/or identified. In some embodiments, a first region of interest is determined based on rows of pixels of interest identified in the first low resolution image dataset and/or columns of pixels of interest identified in the first low resolution image dataset. For example, the rows and/or columns of interest may be rows and/or columns depicting an object or item moving through the FOV of the image acquisition assembly (e.g., that are detected via edge detection, linear filtering, another image analysis technique, etc.)

At block 506, a first high resolution image dataset is captured by the image acquisition assembly based on the first region of interest. In various embodiments, the field of view (FOV) of the first high resolution image may be smaller than the FOV of the first low resolution image (e.g., the FOV of the first high resolution image dataset encompasses the first region of interest; the first region of interest is a portion of the first low resolution image dataset). At block 508, a second low resolution image dataset is captured by the image acquisition assembly. At block 510, a second region of interest from the second low resolution image dataset is determined. In some embodiments, the second region of interest is determined based on rows of pixels of interest identified in the second low resolution image dataset and/or columns of pixels of interest identified in the second low resolution image dataset.

At block 512, a second high resolution image dataset is captured by the image acquisition assembly based on the second region of interest. Generally speaking, the first region of interest and the second region of interest are associated with each other (e.g., one entity moving across the low resolution FOV) but may appear in different portions of the FOV of the image acquisition assembly. Moreover, the first high resolution image dataset and the second high resolution image dataset correspond to the same generalized region of interest at different positions (e.g., physically and temporally) within the low resolution FOV (e.g., within the low resolution image datasets). At block 514, an image feature (e.g., an item or object in the FOV) is identified based on the first high resolution image dataset and/or the second high resolution image dataset. For example, the first high resolution image dataset may depict the image feature more clearly then the second high resolution image dataset, or vice versa. For example, an image dataset may be noisier then the other, the image feature may be obscured in some way (e.g., by a reflection, shadow, etc.), an image dataset may only depict a portion of the image feature, etc. Accordingly, the image feature may be identified in the clearer high resolution image dataset. In some scenarios, both image datasets may be clear, and the method may include identifying the image feature in each high resolution image dataset and verifying that the image feature depicts the same object or item. At block 516 and in some embodiments, a symbology depicted within the identified image feature is identified. At block 518 and in some embodiments, the symbology depicted within the identified image feature is decoded.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAS, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A computing system comprising:
one or more processors;
an image acquisition assembly; and
one or more memories including computer-executable instructions stored thereon that, when executed by the one or more processors cause the computing system to:
capture, by the image acquisition assembly, a first low resolution image dataset;
determine a first region of interest from the first low resolution image dataset;
capture, by the image acquisition assembly, a first high resolution image dataset based on the first region of interest;
capture, by the image acquisition assembly, a second low resolution image dataset;
determine a second region of interest from the second low resolution image dataset;
capture, by the image acquisition assembly, a second high resolution image dataset based on the second region of interest; and
identify, based on one or more of: (i) the first high resolution image dataset or (ii) the second high resolution image dataset, an image feature.

2. The computing system of claim 1, wherein the image acquisition assembly is further configured to consecutively capture the first low resolution image dataset, the first high resolution image dataset, the second low resolution image dataset, and the second high resolution image dataset.

3. The computing system of claim 1, wherein the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset,
and wherein the second set of image acquisition parameters are determined based on the first low resolution image dataset, and the fourth set of image acquisition parameters are determined based on the second low resolution image dataset.

4. The computing system of claim 1, wherein the first low resolution image dataset and the second low resolution image dataset correspond to a field of view of the image acquisition assembly and wherein the first high resolution image dataset and the second high resolution image dataset correspond to respective first and second portions of the field of view of the image acquisition assembly.

5. The computing system of claim 1, wherein the computer-executable instructions, when executed by the one or more processors, further cause the computing system to:
determine the first region of interest based on one or more of: (i) rows of pixels of interest identified in the first low resolution image dataset, or (ii) columns of pixels of interest identified in the first low resolution image dataset; and
determine the second region of interest based on one or more of: (i) rows of pixels of interest identified in the second low resolution image dataset, or (ii) columns of pixels of interest identified in the second low resolution image dataset.

6. The computing system of claim 5,
wherein the computer-executable instructions, when executed by the one or more processors, further cause the computing system to:
crop, based on the first region of interest associated with the first low resolution image dataset, an initial first high resolution image dataset corresponding to a field of view of the image acquisition assembly to generate the first high resolution image dataset corresponding to a first portion of the field of view of the image acquisition assembly; and
crop, based on the second region of interest associated with the second low resolution image dataset corresponding to the field of view of the image acquisition assembly, an initial second high resolution image dataset to generate the second high resolution image dataset corresponding to a second portion of the field of view of the image acquisition assembly.

7. The computing system of claim 1, wherein the computer-executable instructions, when executed by the one or more processors, further cause the computing system to:
identify a symbology depicted within the identified image feature; and
decode the symbology depicted within the identified image feature.

8. The computing system of claim 1, wherein identifying the image feature further includes:
identifying one or more objects included in the first region of interest and in the second region of interest; and
determining one or more of: (i) a location of the one or more objects or (ii) a configuration of the one or more objects.

9. A computer-implemented method comprising:
capturing, by an image acquisition assembly, a first low resolution image dataset;
determining a first region of interest from the first low resolution image dataset;
capturing, by the image acquisition assembly, a first high resolution image dataset based on the first region of interest;
capturing, by the image acquisition assembly, a second low resolution image dataset;
determining a second region of interest from the second low resolution image dataset;
capturing, by the image acquisition assembly, a second high resolution image dataset based on the second region of interest; and
identifying, based on one or more of: (i) the first high resolution image dataset or (ii) the second high resolution image dataset, an image feature.

10. The method of claim 9, wherein the image acquisition assembly is further configured to consecutively capture the first low resolution image dataset, the first high resolution image dataset, the second low resolution image dataset, and the second high resolution image dataset.

11. The method of claim 9, wherein the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset,
and wherein the second set of image acquisition parameters are determined based on the first low resolution image dataset, and the fourth set of image acquisition parameters are determined based on the second low resolution image dataset.

12. The method of claim 9, wherein the first low resolution image dataset and the second low resolution image dataset correspond to a field of view of the image acquisition assembly and wherein the first high resolution image dataset and the second high resolution image dataset correspond to respective first and second portions of the field of view of the image acquisition assembly.

13. The method of claim 9, further comprising:
determining the first region of interest based on one or more of: (i) rows of pixels of interest identified in the first low resolution image dataset, or (ii) columns of pixels of interest identified in the first low resolution image dataset; and
determining the second region of interest based on one or more of: (i) rows of pixels of interest identified in the second low resolution image dataset, or (ii) columns of pixels of interest identified in the second low resolution image dataset.

14. The method of claim 13, further comprising:
cropping, based on the first region of interest associated with the first low resolution image dataset, an initial first high resolution image dataset corresponding to a field of view of the image acquisition assembly to generate the first high resolution image dataset corresponding to a first portion of the field of view of the image acquisition assembly; and
cropping, based on the second region of interest associated with the second low resolution image dataset corresponding to the field of view of the image acquisition assembly, an initial second high resolution image dataset to generate the second high resolution image dataset corresponding to a second portion of the field of view of the image acquisition assembly.

15. The method of claim 9, further comprising:
identifying a symbology depicted within the identified image feature; and
decoding the symbology depicted within the identified image feature.

16. The method of claim 9, wherein identifying the image feature further includes:
identifying one or more objects included in the first region of interest and in the second region of interest; and
determining one or more of: (i) a location of the one or more objects or (ii) a configuration of the one or more objects.

17. A non-transitory computer readable medium containing program instructions that when executed, cause a computer to:
capture, by an image acquisition assembly, a first low resolution image dataset;
determine a first region of interest from the first low resolution image dataset;
capture, by the image acquisition assembly, a first high resolution image dataset based on the first region of interest;
capture, by the image acquisition assembly, a second low resolution image dataset;
determine a second region of interest from the second low resolution image dataset;
capture, by the image acquisition assembly, a second high resolution image dataset based on the second region of interest; and
identify, based on one or more of: (i) the first high resolution image dataset or (ii) the second high resolution image dataset, an image feature.

18. The non-transitory computer readable medium of claim 17, wherein the image acquisition assembly include a first set of image acquisition parameters associated with capturing the first low resolution image dataset, a second set of image acquisition parameters associated with capturing the first high resolution image dataset, a third set of image acquisition parameters associated with capturing the second low resolution image dataset, a fourth set of image acquisition parameters associated with capturing the second high resolution image dataset,
and wherein the second set of image acquisition parameters are determined based on the first low resolution image dataset, and the fourth set of image acquisition parameters are determined based on the second low resolution image dataset.

19. The non-transitory computer readable medium of claim 17, containing further program instructions that when executed, cause a computer to:
determine the first region of interest based on one or more of: (i) rows of pixels of interest identified in the first low resolution image dataset, or (ii) columns of pixels of interest identified in the first low resolution image dataset; and
determine the second region of interest based on one or more of: (i) rows of pixels of interest identified in the second low resolution image dataset, or (ii) columns of pixels of interest identified in the second low resolution image dataset.

20. The non-transitory computer readable medium of claim 17, containing further program instructions that when executed, cause a computer to:
identify a symbology depicted within the identified image feature; and
decode the symbology depicted within the identified image feature.
